(19) United States
(12) Patent Application Publication
(10) Pub. No.: US 2008/0034351 A1
(43) Pub. Date: Feb. 7, 2008

(54) Process for making software diagnostics more efficient by leveraging existing content, human filtering and automated diagnostic tools

(76) Inventors: William Pugh, Seattle, WA (US); Ryan Sweet, Seattle, WA (US); Steve Jacobson, Redmond, WA (US); Christian Hansson, Port Orchard, WA (US); Ross Arden Jekel, Lynnwood, WA (US); Yongshao Ruan, Seattle, WA (US)

Correspondence Address: HELLER EHRMAN LLP, 275 MIDDLEFIELD ROAD, MENLO PARK, CA, 94025-3506, US

(21) Appl. No.: 11/768,337

(22) Filed: Jun. 26, 2007

Related U.S. Application Data
(60) Provisional application No. 60/816,797, filed on Jun. 26, 2006.

(51) Int. Cl. G06F 9/44

(52) U.S. Cl. 717/128

(57) ABSTRACT

Improved methods of software diagnostics are provided. Searches of data sources are conducted using search terms from internal computer information to obtain searched data. The searched data is processed by extracting technical features. The technical features are indexed to create indexes that can be searched via machine state. Filtering is conducted over the gathered data to create feeds that are available to customers.

### CROSS-REFERENCE TO RELATED APPLICATIONS

This application claims the benefit of U.S. Ser. No. 60/816,797, filed Jun. 26, 2006, which application is fully incorporated herein by reference.

### BACKGROUND

1. Field of the Invention

The present invention relates to software tools for assisting software developers in the task of monitoring and analyzing the execution of computer programs, such as during the debugging process.

2. Description of the Related Art

Despite the significant diversity in software tracing and debugging programs (“debuggers”), virtually all debuggers share a common operational model: the developer notices the presence of a bug during normal execution, and then uses the debugger to examine the program's behavior. The second part of this process is usually accomplished by setting a breakpoint near a possibly flawed section of code, and upon reaching the breakpoint, single-stepping forward through the section of code to evaluate the cause of the problem.

Two significant problems arise in using this model. First, the developer needs to know in advance where the problem resides in order to set an appropriate breakpoint location. Setting such a breakpoint can be difficult when working with an event-driven system (such as the Microsoft Windows.®. operating system), because the developer does not always know which of the event handlers (callbacks) will be called.

The second problem is that some bugs give rise to actual errors only during specific execution conditions, and these conditions cannot always be reproduced during the debugging process. For example, a program error that occurs during normal execution may not occur during execution under the debugger, since the debugger affects the execution of the program. This situation is analogous to the famous “Heizenberg effect” in physics: the tool that is used to analyze the phenomena actually changes its characteristics. The Heizenberg effect is especially apparent during the debugging of time-dependent applications, since these applications rely on specific timing and synchronization conditions that are significantly altered when the program is executed step-by-step with the debugger.

An example of this second type of problem is commonly encountered when software developers attempt to diagnose problems that have been identified by customers and other end users. Quite often, software problems appear for the first time at a customers site. When trying to debug these problems at the development site (typically in response to a bug report), the developer often discovers that the problem cannot be reproduced. The reasons for this inability to reproduce the bug may range from an inaccurate description given by the customer, to a difference in environments such as files, memory size, system library versions, and configuration information. Distributed, client/server, and parallel systems, especially multi-threaded and multi-process systems, are notorious for having non-reproducible problems because these systems depend heavily on timing and synchronization sequences that cannot easily be duplicated.

When a bug cannot be reproduced at the development site, the developer normally cannot use a debugger, and generally must resort to the tedious, and often unsuccessful, task of manually analyzing the source code. Alternatively, a member of the software development group can be sent to the customer site to debug the program on the computer system on which the bug was detected. Unfortunately, sending a developer to a customer's site is often prohibitively time consuming and expensive, and the process of setting up a debugging environment (source code files, compiler, debugger, etc.) at the customer site can be burdensome to the customer.

Some software developers attempt to resolve the problem of monitoring the execution of an application by imbedding tracing code in the source code of the application. The imbedded tracing code is designed to provide information regarding the execution of the application. Often, this imbedded code is no more than code to print messages which are conditioned by some flag that can be enabled in response to a user request. Unfortunately, the imbedded code solution depends on inserting the tracing code into the source prior to compiling and linking the shipped version of the application. To be effective, the imbedded code must be placed logically near a bug in the source code so that the trace data will provide the necessary information. Trying to anticipate where a bug will occur is, in general, a futile task. Often there is no imbedded code where it is needed, and once the application has been shipped it is too late to add the desired code.

Another drawback of current monitoring systems is the inability to correctly handle parallel execution, such as in a multiprocessor system. The monitoring systems mentioned above are designed for serial execution (single processor) architectures. Using serial techniques for parallel systems may cause several problems. First, the sampling activity done in the various parallel entities (threads or processes) may interfere with each other (e.g., the trace data produced by one entity may be over written by another entity).

Second, the systems used to analyze the trace data cannot assume that the trace is sequential. For example, the function call graph in a serial environment is a simple tree. In a parallel processing environment, the function call graph is no longer a simple tree, but a collection of trees. There is a time-based relationship between each tree in the collection. Displaying the trace data as a separate calling tree for each entity is not appropriate, as this does not reveal when, during the execution, contexts switches were done between the various parallel entities. The location of the context switches in the execution sequence can be very important for debugging problems related to parallel processing.

### SUMMARY

An object of the present invention is to provide improved methods of software diagnostics.

Another object of the present invention is to provide improved methods of software diagnostics by gathering and digesting information down to the most important nuggets and bugs to help customers preventatively avoid problems.

Yet another object of the present invention is to provide improved methods of software diagnostics by using probes that can pull information from a running process and help it match against the information gathered as well as information created.

A further object t of the present invention is to provide improved methods of software diagnostics with newly created indexes to conduct searches.

Another object of the present invention is to provide improved methods of software diagnostics where items from machine data are extracted from human data to be operated on to produce digested data as feeds.

Still a further object of the present invention is to provide improved methods of software diagnostics using 3 stack trace matching.

These and other objects of the present invention are achieved in a method of software diagnostics. Searches of data sources are conducted using search terms from internal computer information to obtain searched data. The searched data is processed by extracting technical features. The technical features are indexed to create indexes that can be searched via machine state. Filtering is conducted over the gathered data to create feeds that are available to customers.

### BRIEF DESCRIPTION OF THE DRAWINGS

FIG. 1 is a flow chart illustrating a process for one embodiment of the present invention.

FIG. 2 is a block diagram illustrating one embodiment of a system of the present invention.

FIG. 3 illustrates one embodiment of a stack trace extraction process of the present invention.

FIG. 4 illustrates another embodiment of a stack trace extraction process of the present invention.

FIG. 5 illustrates one embodiment of a feed configuration summary of the present invention.

FIG. 6 illustrates one embodiment of adding/editing a feed of the present invention.

FIG. 7 illustrates one embodiment of adding/editing a feed in an advanced tab of the present invention.

FIG. 8 is a flow chart illustrating one embodiment of adding stack traces of the present invention.

FIG. 9 is a flow chart illustrating one embodiment of computing alignment scores in stack traces of the present invention.

### DETAILED DESCRIPTION

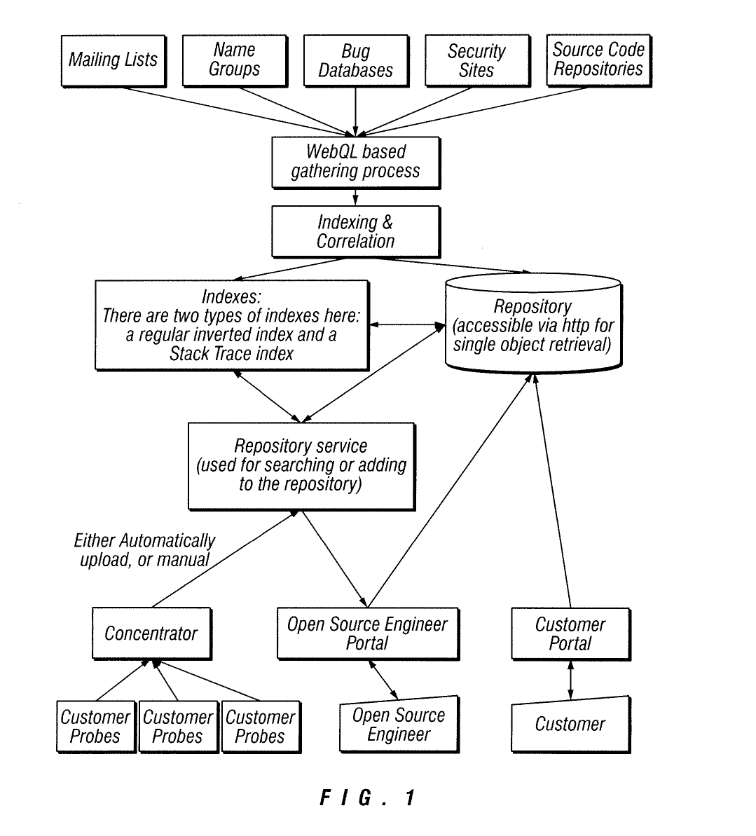

In one embodiment of the present invention, illustrated in FIG. 1, the methods and systems of the present invention make software diagnostics more efficient. This can be achieved by, (i) gathering information and digest it down to the most important nuggets and bugs to help customers preventatively avoid problems, and (ii) use probes that can pull information from a running process and help it match against the information gathered as well as information created.

There are three important parts of the information gathering process. In one embodiment, data is pulled from external data Sources. In one embodiment of the present invention raw data is filtered through a mix of automatic and manual processes. One embodiment of the present invention also opens up manual filtering on non-bug content by allowing tagging and annotations to be added on any content similar to the way the meta data is added to bug content.

A feedback loop can be used to provide the filtering. Additionally, the digested data can be made available for customers via customized feeds and emails.

Items from machine data can be extracted from human data to be operated and produce the digested data as feeds. This can be achieved with 3 stack trace matching.

In one embodiment of the present invention, methods and systems are provided for software diagnostics. Data sources are searched using search terms from internal computer information to obtain searched data. The searched data can include extracted features of the data, connocal forms of the data and tags. A variety of data sources can be accessed including but not limited to, mailing lists, newsgroups, bugs entered through community sites, changes in source code, security sites, an internal certification process and an internal bug tracking system. A summarization can be performed for the searches.

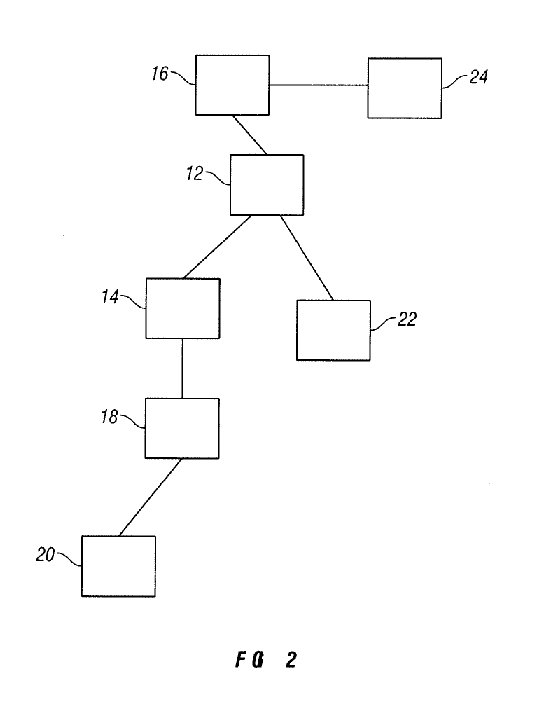

In one embodiment, illustrated in FIG. 2, a system 10 is provided for software diagnostics. The system 10 includes a gatekeeper server 12 that receives search requests, and then communications with a repository server 14. The repository server 14 can include first and second indexes, with the first index being an inverted index that is used for general full text searches, and the second index is used for matching stack traces. The new indexes are used to conduct the search.

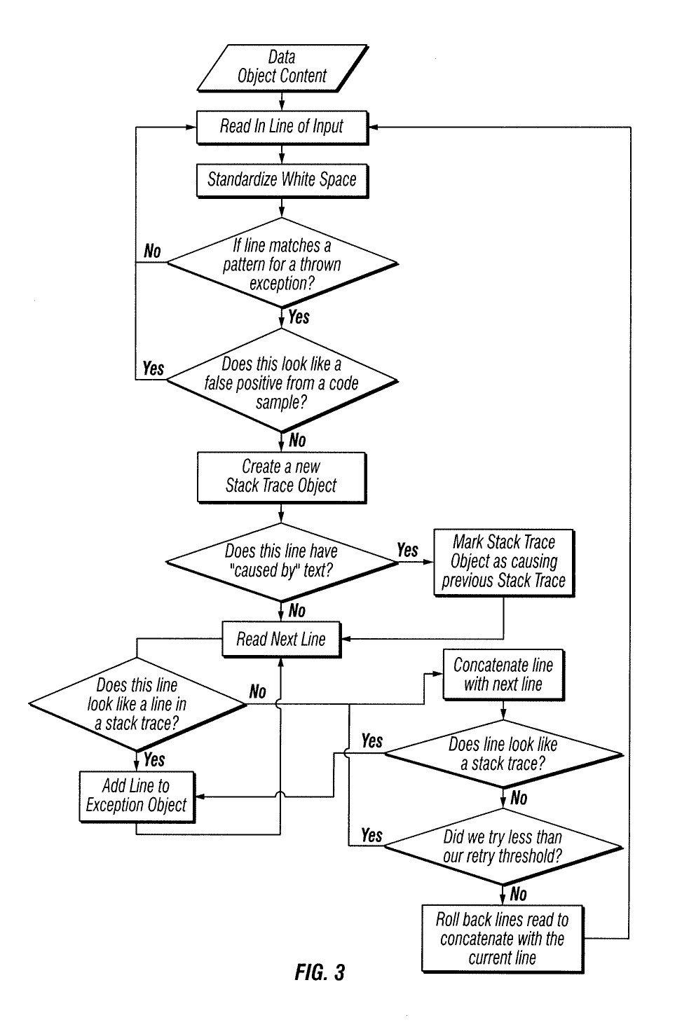

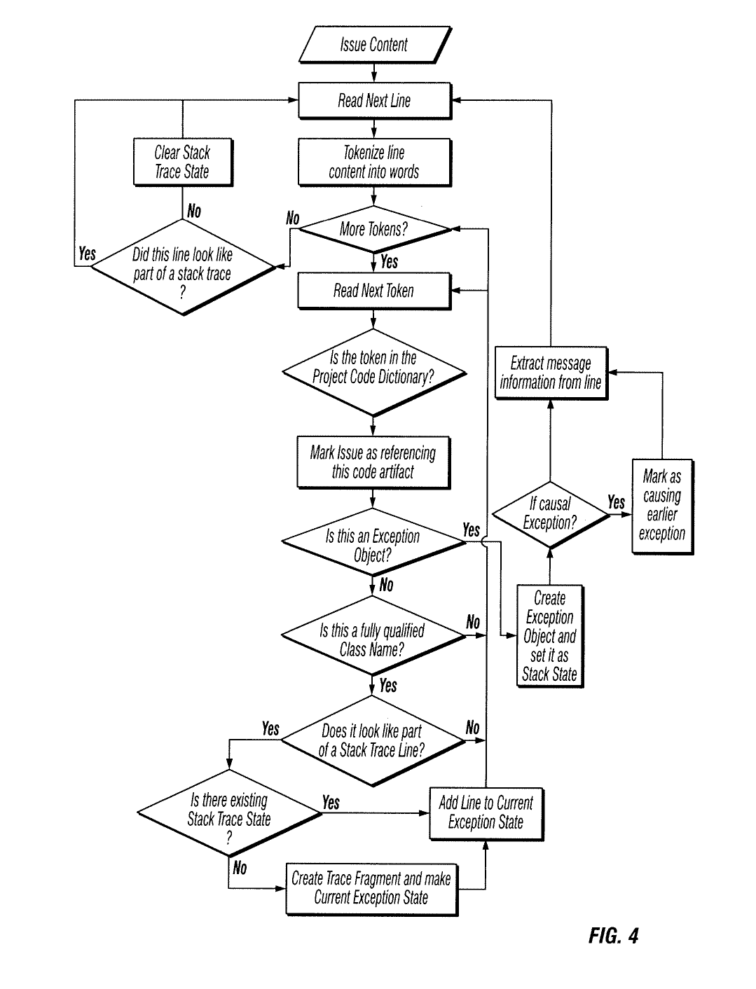

In one embodiment, stack traces are extracted for the purpose of matching and researching using machine state rather than key words, as illustrated in FIGS. 3 and 4, and as more fully explained below.

The inverted index for the data can be a standard index. In addition to this, however, one embodiment of the present invention also builds a unique index. This additional index is for quickly matching stack traces to other similar stack traces. In one embodiment of the present invention this index is built via a combination of tables in a database, and a series of string alignment algorithms. The mechanism for how this occur is first all exceptions are added to a database. Each exception has an entry in the Exception table and at least one entry in the stack trace element table. Each element in the stack trace element table represents one frame of the stack trace.

When the gathering process is complete, all information, tags and relationships are kept in the repository server 14 The repository server 14 scales to large amounts of data. To accommodate this, in one embodiment the repository server 14 is implemented on the Reiser4 file system, and organizes unique identifiers for objects and relationships between objects as file system operations. A link is simply a URL, so it is easy to find the object being linked to. The unique ID for an object is it's path. If the unique ID is known, the object can be obtained from a file server.

To do a match, the system 10 creates a query against the data base that looks for all traces that have similar stack trace elements. This is a match in class name and method name, but does not require a match in line number. After obtaining this set of elements, the system 10 breaks the stack trace down into tokens, considers each frame as a unique element, and computes global alignment scores for each of the traces against the matching against stack traces. The system 10 computes the global alignment against two stack traces via an algorithm such as the one by S. B. Needleman & C. D. Wunsch in 1970 for comparing amino acids, incorporated herein by reference. The tokens operated on can be stack frames and the substitution scoring used in each step can depend on whether the current frame matches class name, method name, line name and the like.

In one embodiment, an optimization is performed that further breaks the tokens into blocks of either runs of potential matches, or runs of definite non-matches. Potential match means that a given stack trace element has a class name that occurs in the source stack trace.

The gatekeeper server 12 takes the search requests and communicates with the repository server 14. In response to the search requests, the repository server 14 tells the gatekeeper server 12 which indices to use and which to bring back.

The gatekeeper server 12 implements a web services interface 16 coupled to the repository server 14 at which time the search is initiated. In one embodiment, the repository server 14 is structured in a hierarchy directory structure. This type of structure improves search performance.

A feed generator server 18 communicates with a user database 20. The feed generator server 18 communicates with the repository server 14. A concentrator server 22 listens to probe events and communicates the probe events to the gatekeeper server 12 which then communicates this to the repository server 14. The probes reside on customer machines as software entities. A customer portal 24 is used by a customer to issue search request and to set up the customers' feeds.

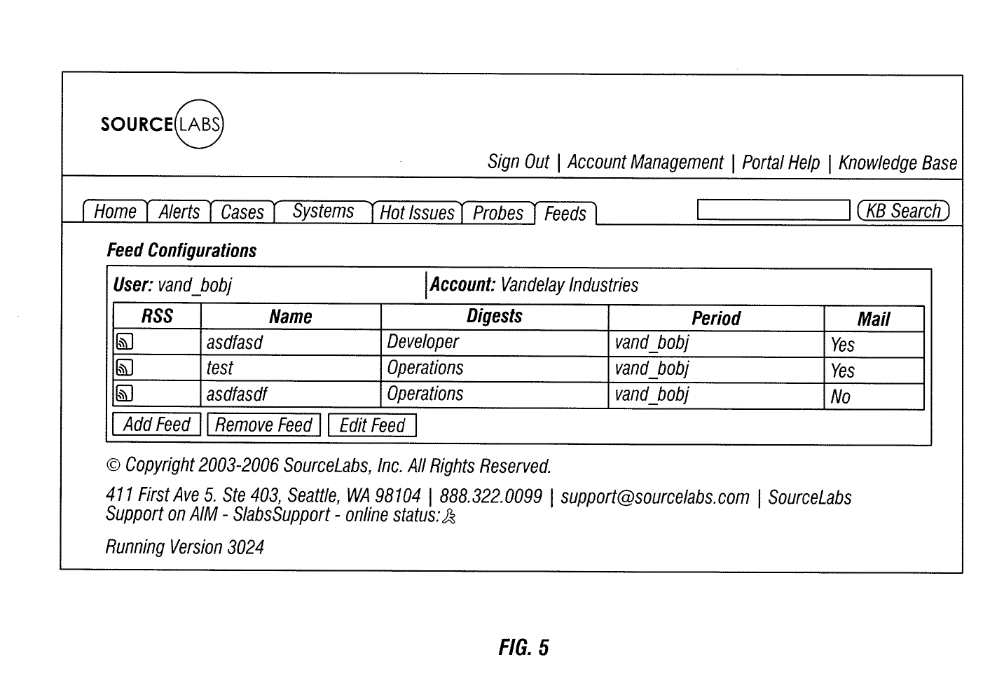

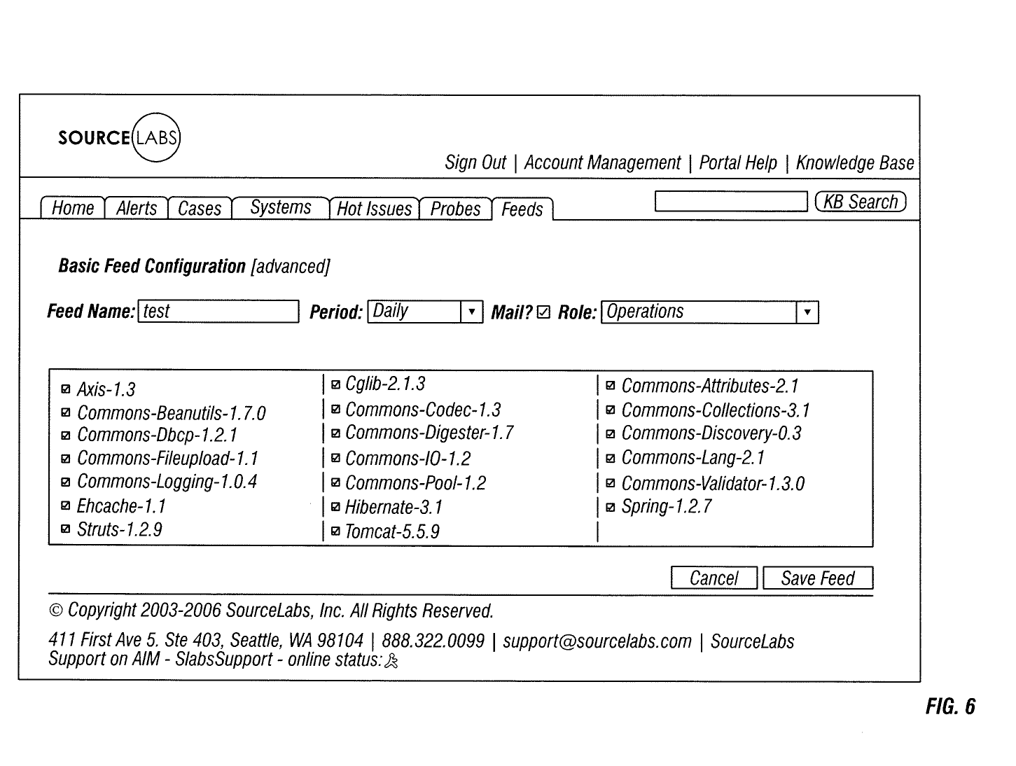

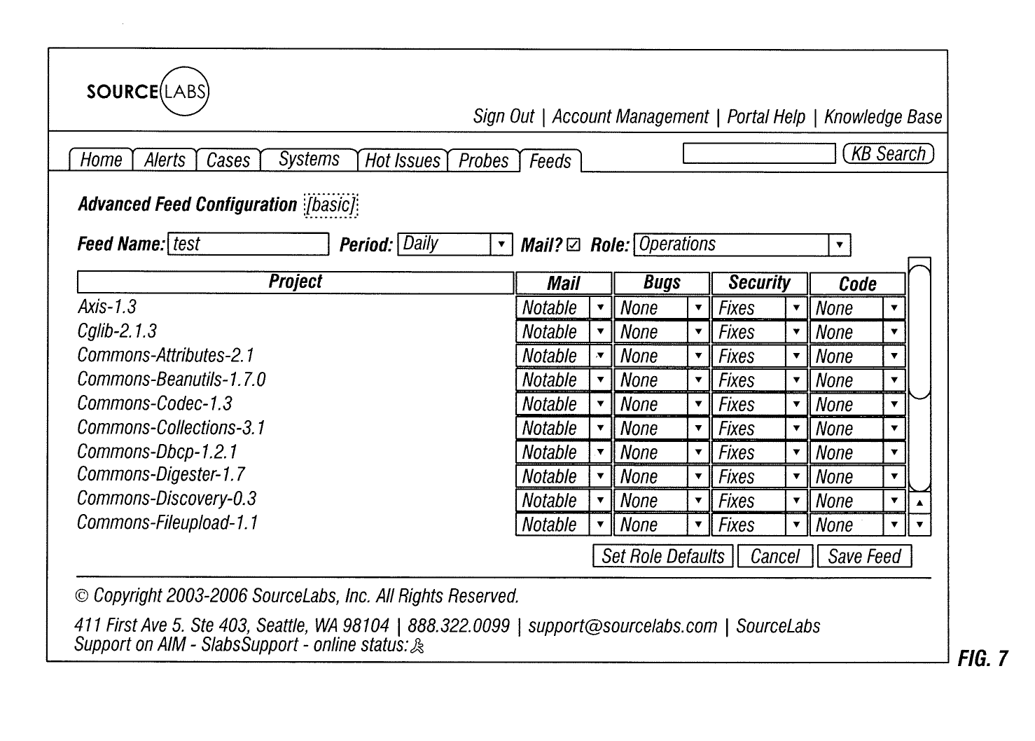

The system 10 allows for the creation of configurable feeds, as illustrated in FIGS. 5-7. The repository server 14, customer portal 24 and the feed generator 18 are used to create the configurable feeds. In one embodiment, at least a basic and an advanced feed are provided. The basic feed permits a user to, name the feed, select a choice of role, select a choice of stack, select a choice of time period and determine if the feed will be sent as mail.

In one embodiment, the system 10 uses a feed process that allows users to specifically choose the wanted information, as digests, and these digests are then either sent through mail, or exposed as RSS. In one embodiment, the user Interface 16 can be used to create configurable feeds through a web page.

In one embodiment, the system 10 uses a bug tracking system for special fields that exist for each bug. Examples of the special fields include but are not limited to, an original bug ID that is a URL to the original bug in the software, an external Issue type that marks the kind of issue it is and an external annotation that is the text describing the issue put in front of customers and will show up through feeds and the like. It will be appreciated that either single or multiple servers can be utilized. Multiple servers reduce bottleneck.

In one embodiment, users are logged onto customer portals 24 that enable the users to use feeds tab. The users can add, remove and modify the functionality of the feeds.

Examples of feeds include but are not limited to, feed name, feed time period, description of what is in the feed, yes or no based on whether the feed should be sent as mail, a URL to obtain the RSS feed from and the like.

One embodiment of the present invention starts off by pulling in many free data sources from the web. The different types of data that can be collected are, mailing lists, bugs entered via community sites, changes in source code, security sites, internal certification processes, an internal bug tracking system of the present invention and the like.

In various embodiments, data can be pulled in via several ways. For mailing lists, there are three ways that this can be achieved. The first is to scrape web sites that host mailing lists and pull the content from the HTML. The second is to download .MBOX files for lists that have archives. The third is to enlist the robot in the embodiment of the present invention in the mailing lists to keep up to date.

For bugs, there are two ways to pull the data. The first is to scrape the HTML rendered by the bug databases, and using URLs to query for the different projects and desired sort orders. The second is to use web services over a standard protocol such as SOAP to access bug information.

For changes in source code, source code repositories can be polled once a day to look for any changes that have been committed. This information is then logged as are the differences.

In one embodiment, web scraping is done on several security related sites for tracking security issues. This can be achieved by hitting the relevant pages that refer to security problems and scraping the relevant information from the HTML. In one embodiment, the system 10 runs through certification. In this embodiment the probe communicates with the repository server 14 and saves off stack trace and error information. This information can be stored in the repository server 14 in an XML file.

In one embodiment data is gathered from different data sources and then saved such as in the form of XML files. Preferably, mail files are stored in .MBOX format.

The searched data can be ranked using heuristics. For each data type a number of heuristics can be used for pulling out notable items. This can be achieved by looking at different aspects of the items, and then getting the proper mix of aspects to look for certain content types, which depend on the actual context of the item. For example, finding notable mails in a mailing list aimed at developers can have different thresholds or mixes of heuristics than a mailing list aimed at users. Examples of heuristics that can be looked at include:

mail threads, bugs, code, and the like.

For mail threads, the aspects include, how many responses in the thread, who wrote the mails, is this thread generated from a code check-in event, this thread generated from a bug activity event, and the like.

For bugs, the aspects include, how was the bug get resolved, who opened it, who resolved it, was it fixed or not, how long has it sat un touched

For code, the aspects include, how did this check-in affect code complexity, how much churn did this check-in cause, does this check-in look related to a bug, how close is the project to releasing and the like.

The searched data is processed by extracting technical features. The technical features are indexed that can be searched by machine state. Filtering is used over the gathered data to create feeds that are available to customers. Data mining can also be used to create the feeds.

After pulling in items from the many data source, one embodiment of the present invention filters through the data to pull out the important from the unimportant information. This can be done through both automatic and manual filtering and ranking methods.

In one embodiment, semi-structured information related to the code is extracted. Regular expressions are used to look for exception names, and the formats that popular VIRTUAL MACHINES print out. By way of illustration, and without limitation, a regular expression finds a line that looks like it has an exception name and starts a stack trace, and looks like the following:

“.*?(.{0,16}?)((?:\\w+\\.)+w*(?:Exception|Error))((?:[\\s:].*)?)

Several other regular expressions can also be used including determining if, the line describes the exception being thrown, and the error string being use, the line describes a rethrow, the line looks like the first line of a stack trace, the line looks like a part of a stack trace and the like.

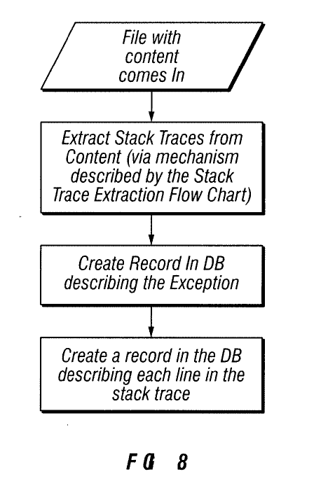

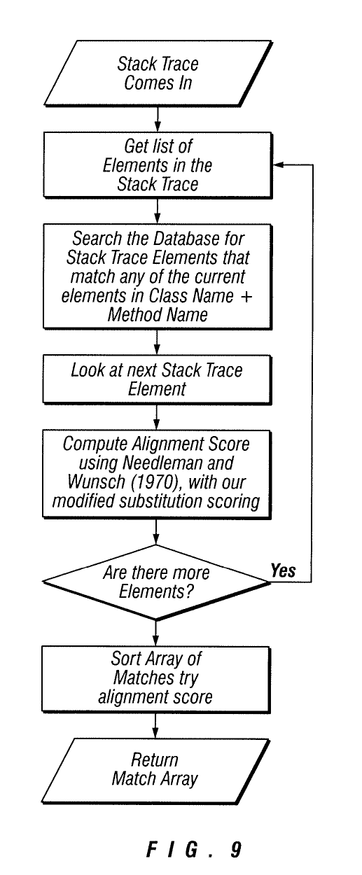

This process is described in the stack trace extraction flow chart of FIGS. 8 and 9.

In another embodiment, the stack trace extraction process pulls out more interesting information than just stack traces. This can be achieved by creating a large dictionary of classes, methods, and the like from the base source code. This information is then used to pull out either stack traces, sample code or simply references to known items and the like and called dictionaries, such as project code dictionaries, because they are built per project and on code related artifacts. In one embodiment, compiler tools are used to create the dictionaries. A hash table or a suffix tree can then be created from the dictionaries.

In one embodiment, a dictionary of classes and methods is created from the base source code. The dictionary is used to pull out either stack traces, sample code or references to items. The dictionaries can be build in part on code related artifacts.

In one embodiment, compiler tools are used to create the dictionaries. A hash table or a suffix tree can then be created from the dictionaries.

The purpose of the feeds is a preventative issue. In one embodiment, a continuous support process is directed to help diagnose and solve customer problems faster and more efficiently.

This can be achieved with probes, web services and an engineer portal. The probes attach to a running process and are able to keep track of problems that occur in a low latency manner, as well as to provide additional information in an easy mechanism. The web services are built around the repository server 14 described above, for sending down customer traces or error information, as well as searching against what is already present. The engineer portal is built around the repository's web services, which builds user interfaces 16 and tools for engineers trying to diagnose and solve problems.

In one embodiment, the probe is a JVMTI agent capable of instrumenting source code. The probes catch certain events, or cause things to happen at certain points in execution. In one embodiment, when the Java virtual machine is started, the probe agent looks into a certain directory to determine what instrumentation to start with, and then instructs to start paying attention to certain events. By way of illustration, and without limitation, an example is a certain exception being throw. Other examples, include but are not limited to, patterns of memory usage (as determinable by cheap polling techniques), garbage collection behavior, CPU patterns and the like.

If an event occurs, the probe looks to it's configuration and determine which information it can gather about the running system. The probe sends that information to a concentrator component of the concentrator server 22, which can be in the same process, different process or a different machine. The concentrator server 22 determines whether to write it to file, send it out as mail, or send it back. In one embodiment, the data types that can be pulled out of the system 10 are any objects of the system 10 including but not limited to, class instance member variables, class static variables, local variables and the like.

The probe agent can take configuration updates on the fly, so that the VM does not need to be stopped and started in order for one object to be able to change what events would need to be triggered on as well as what information would need to be gathered on.

For customers interested in running with automatic error notification, the probes send data directly to the system 10. This enters into an automated process where the system 10 takes the customer notification, and turns it into a case.

The repository server 14 is the place where new customer alert information comes in. The repository server 14 is also the place that engineers look for intelligent matching.

When a customer's issue is sent in via a probe, it is added to the repository server 14 but may not be searchable. The repository server 14 creates a new case in the case management systems, which guards against creating duplicate cases and throttles case creation via simple mechanisms such as exact stack trace matching. When the issue is created it can be assigned to an engineer.

When a customer sends in a request, or when an engineer is assigned a case, the engineer is able to search and navigate the repository server 14. This can be accomplished through the engineering portal. This provides search and navigation facilities on the repository server 14 as well as tagging.

Engineers can add additional information about the case to the engineering portal which makes later automated matches better. This is achieved by creating tags (relationships), and marking the more relevant ones.

In one embodiment, a dictionary is created using existing compiler tools such as ETAGS, and then from that file creates either a hash table, or a suffix tree, depending if a faster run time is needed.

A daemon can create RSS files for the new content created for the different content types for each different project. As a way to provide this information to customers a custom feed process can be used that allows users to choose specifically what information, as digests, is wanted. These digests can then be sent through mail, or exposed as RSS. This general process is called a feed and can be distributed as RSS or through e-mail.

The user interface i6 is used to create configurable feeds can be a web page. A user can log onto the customer portal 24 and go to a feeds tab. There, the user can have a shopping cart paradigm that provides a manage feeds page. On this page, the user sees a list of the feeds that have been signed up for, as well as an add, remove, modify functionality for the feeds.

The listed feeds show, feed name, feed time period, basic description of what is in the feed, yes or no based on whether the feed should be sent as mail, a URL to obtain the RSS feed from and the like.

In one embodiment of the present invention, when adding or modifying a feed, there are two views: basic and advanced. The basic view can include, the name for the feed, a name the user can put on a feed, a choice of role with the basic roles being developer, operations and security officer, a choice of stack that can be Sash Stack 1.2 and Sash Server 1.2. where the difference between these is that the Sash Server stack includes the SASH Stack plus Tomcat and Apache Web Server, choice of time period such as daily, weekly, bi-Weekly and the like, whether the feed will be sent as mail and the like

Additionally, the system 10 can provide the ability to choose to go into an advanced view for a feed. This provides a more specific set of choices on the topics that can be sent. This page can include everything listed above, with the exception of choice of role and choice of stack. This page can include a grid that lists each of the main components. Adjacent to these components is a set of dropdowns where users can choose the level of digests they want for a specific feed.

The pre-built configuration roles break down to the following settings, (i) developer for notable issues, notable mail, security Issues, notable code, (ii) operations for notable issues and security patches and (iii) security officer for security suspects.

In one embodiment, the feed is created in a feed building process. The gatekeeper server 12 goes to the repository server 14, and from the repository server 14 weightings for each of item in a category are applied for the feed. The gateway server 12 remains coupled to the repository server 14 until the feed process begins to create a custom feed for a customer.

The repository server 14 contains the prebuilt CSS digests for the projects and content types in the projects. The customer portal 24 includes the pages listed above and provides the user interface 16 for users to configure specific feeds as well as the logic to put new feed information

The feed generator server 18 is started by scheduling software, such as cron, once a day. The feed generator server 18 looks at new digests created by Cascadia, and generates the resultant unique feeds. Since, it is expected that there are redundant feed definitions, the feed generator server 18 obtains the unique set of feed definitions and goes through Cascadia to generate a master file for everything on this list. It then goes through each individual feed and creates a link to the master feed file that lists it's contents. This link is accessible through the feed portal as the RSS implementation. If the given feed requests an email notification, the feed generator server 18 sends an email. If a user sets up a feed for coming weekly, or bi-weekly, it will show up on Monday. This provides a more reusable processes. A customer is able to select a project and create the level of notification.

The annotated issues are noted in the repository server 14 and can be attached to the bug.

With the gathering process the system 10 looks through the bug tracking system similar in the way that it looks through bug trackers. The difference is that special attention is paid to special fields that exist for each bug. These fields include but are not limited to, original bug ID (this can be, by way of illustration, the URL to an original bug in the software project), external issue type (this marks what kind of issue it is, including not but not limited to security, bug, readme and the like), external annotation (this is the text describing the issue that the system 10 puts in front of customers and shows up through the feeds) and the like.

In addition to the automatic filtering techniques used by the system 10, engineers can look at and triage every bug that is entered against a supported project. This can be done automatically to create issues in the private bug tracking system. Bugs are then assigned to engineers to look at. If the issue is considered significant, either because it needs a patch, or a README file, it is then marked as being special in the bug tracker system.

Software bugs are triaged in order to determine a level of importance of the bug elements. The triaging can include at least one of, marking and annotating issues, reasons to fix the bug and reasons not to fix the bug.

Customer responses can be data mined.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A method of performing software diagnostics, comprising:
conducting searches of data sources using search terms from internal computer information to obtain searched data,
processing the searched data by extracting technical features;
indexing the technical features to create indexes that can be searched via machine state, and
using filtering over the gathered data to create feeds that are available to customers.

2. The method of claim 1, further comprising:
data mining the gathered data.

3. The method of claim 1, further comprising:
using the new indexes to conduct the search.

4. The method of claim 1, further comprising:
summarizing.

5. The method of claim 1, wherein items from machine data are extracted from human data to be operated on to produce digested data as feeds.

6. The method of claim 5, wherein 3 stack trace matching is utilized.

7. The method of claim 1, further comprising:
using manual filtering on bug content

8. The method of claim 1, further comprising:
data mining customer responses.

9. The method of claim 1, further comprising:
using a feedback loop to provide the filtering.

10. The method of claim 7, further comprising:
triaging through the bugs to determine what is important.

11. The method of claim 10, wherein the triaging includes at least one of, marking and annotating issues, reasons to fix the bug, and reasons not to fix the bug.

12. The method of claim 11, wherein annotating is noted in a repository.

13. The method of claim 11, wherein annotations are attached to the bug and noted in a repository

14. The method of claim 1, wherein in response to the feed a customer is able to select a project and create a level of notification.

15. The method of claim 14, wherein the feed is created in a feed building process that includes going to a repository and from the repository putting together the feed with weightings for each of an item in a category.

16. The method of claim 15, further comprising:
remaining coupled to the repository until the feed process begins to create a custom feed for a customer.

17. The method of claim 14, wherein the repository is structured in a hierarchy directory structure.

18. The method of claim 17, wherein the hierarchy directory structure is used for improved search performance.

19. The method of claim 1, wherein digested data is made available to the customers through at least one of, a customized feed and an email.

20. The method of claim 1, wherein the data sources are selected from at least one of, mailing lists, newsgroups, bugs entered through community sites, changes in source code, security sites, an internal certification process and an internal bug tracking system.

21. The method of claim 1, further comprising:
extracting semi-structured information related to the software.

22. The method of claim 20, wherein extracting semi-structured information is performed using regular expressions that look for exception names.

23. The method of claim 1, further comprising:
extracting stack traces for the purpose of matching and researching using machine state rather than key words

24. The method of claim 22, further comprising:
creating a dictionary of classes and methods from the base source code, and
using the diction of classes and methods to pull out either stack traces, sample code or references to items.

25. The method of claim 23, wherein the dictionaries are build in part from on code related artifacts.

26. The method of claim 1, further comprising:
performing web scraping on at least security related sites.

27. The method of claim 23, further comprising:
using compiler tools to create the dictionaries; and
creating from the dictionaries a hash table or a suffix tree.

28. The method of claim 1, further comprising:
ranking the searched data using heuristics.

29. The method of claim 28, wherein the searched data is from mail threads.

30. The method of claim 29, further comprising:
determining a number of responses in the mail thread.

31. The method of claim 29, further comprising:
determining authorship of the mail threads.

32. The method of claim 29, further comprising:
determining if the mail thread is from a code check-in event.

33. The method of claim 29, further comprising:
determining if the mail thread is from a bug activity event.

34. The method of claim 28, wherein the searched data is from a bug.

35. The method of claim 34, further comprising:
determining how the bug was resolved.

36. The method of claim 34, further comprising:
determining who opened the bug.

37. The method of claim 34, further comprising:
determining who resolved the bug.

38. The method of claim 34, further comprising:
determining if the bug is fixed.

39. The method of claim 34, further comprising:
determining how long the bug has remained untouched by a software community.

40. The method of claim 28, wherein the searched data is code.

41. The method of claim 40, further comprising:
determining how check-in of the code effected code complexity.

42. The method of claim 40, further comprising:
determining an amount of churn that is created by check-in of the code.

43. The method of claim 40, further comprising:
determining how check-in of the code is related to a bug.

44. The method of claim 1, further comprising:
storing the searched data in a repository.

45. The method of claim 1, wherein the searched data includes extracted features of the data, connocal forms of the data and tags,

46. The method of claim 44, wherein the repository includes first and second indexes, the first index being an inverted index that is used for general full text searches, and the second index is used for matching stack traces.

47. The method of claim 1, further comprising:
looking through a bug tracking system for special fields that exist for each bug.

48. The method of claim 47, wherein the special fields are selected from at least one of, an original bug ID that is a URL to the original bug in the software, an external Issue type that marks the kind of issue it is and an external annotation that is the text describing the issue put in front of customers and will show up through feeds.

49. The method of claim 1, further comprising:
using a feed process that allows users to choose specifically what information is wanted and have these digests either sent through mail, or exposed as RSS.

50. The method of claim 1, wherein an user Interface is used to create configurable feeds through a web page.

51. The method of claim 1, further comprising:
logging users onto customer portals and enabling the user to use a feeds tab.

52. The method of claim 51, further comprising:
allowing users to add, remove and modify functionality of feeds.

53. The method of claim 52, wherein the feeds are selected from at least one of, feed name, feed time period, description of what is in the feed, yes or no based on whether the feed should be sent as mail, and a URL to obtain the RSS feed from.

54. The method of claim 51, wherein at least a basic and an advanced feed are provided.

55. The method of claim 54, wherein the basic feed permits a user to, name the feed, select a choice of role, select a choice of stack, select a choice of time period and determine if the feed will be sent as mail.

56. The method of claim 1, further comprising:
creating configurable feeds.

57. The method of claim 56, wherein a repository, configurable feed portal and a feed generator are used to created the configurable feeds.
